(19) United States
(12) Patent Application Publication
(10) Pub. No.: US 2024/0007012 A1
(43) Pub. Date: Jan. 4, 2024

(54) POWER CONVERTING APPARATUS, AIR CONDITIONER, AND REFRIGERATION CYCLE EQUIPMENT

(71) Applicant: Mitsubishi Electric Corporation, Tokyo (JP)

(72) Inventors: Atsushi TSUCHIYA, Tokyo (JP); Kazunori HATAKEYAMA, Tokyo (JP); Keisuke UEMURA, Tokyo (JP)

(21) Appl. No.: 18/254,777

(22) PCT Filed: Jan. 6, 2021
(86) PCT No.: PCT/JP2021/000206

§ 371 Date: May 26, 2023

(51) Int. Cl. H02M 5/46; H02M 5/458; F24F 11/88

(52) U.S. Cl. CPC H02M 5/46; H02M 5/458; F24F 11/88

(57) ABSTRACT

A converter for converting AC power from an AC power supply into DC power and outputting the DC power, an inverter for converting the DC power outputted from the converter into AC power of a variable frequency and a variable voltage value, and supplying the AC power to a load, a shunt resistor for detecting an output current of the converter, and a control device for controlling the inverter based on the detected output current are provided. The control device calculates an input current of the converter from the output current detected by the shunt resistor, and, when the calculated input current exceeds a predetermined threshold value, the control device causes the manner of operation of said inverter to be changed so as to reduce the input current of the converter.

### CROSS REFERENCE TO RELATED APPLICATION

This application is a U.S. National Stage Application of International Patent Application No. PCT/JP2021/000206 filed on Jan. 6, 2021, the contents of which are incorporated herein by reference.

### TECHNICAL FIELD

The present disclosure relates to a power converting apparatus, an air conditioner, and refrigeration cycle equipment. Particularly, the present disclosure relates to a power converting apparatus receiving AC power from an AC power supply, and outputting AC power of a variable frequency and a variable voltage value, as well as an air conditioner and refrigeration cycle equipment provided with such a power converting apparatus.

### BACKGROUND

The above-mentioned power converting apparatus is used, for example, for supplying power to a motor which drives a compressor in refrigeration cycle equipment, for example in an air conditioner.

In such a case, when a current inputted to the power converting apparatus exceeds a stipulated value due to increase in the load, or a failure of a switching element in a converter, the supply of the power to the power converting apparatus may be interrupted by the action of a circuit breaker. When such an event happens, the operation of the refrigeration cycle equipment is halted, which is not desirable.

It is therefore contemplated to detect the current inputted to the power converting apparatus and to take such measures as reduction of the load when the current is about to exceed the stipulated value. The reduction of the load can be achieved by, for example, lowering the rotational speed of the motor driving the compressor.

When such steps are taken, it is important to detect the current inputted to the power converting apparatus as accurately as possible. This is because, if the detection accuracy is low, it is necessary to start the process of reducing the load allowing a margin corresponding to the detection error. That is, if the reduction of the load is started when actually there is still room, the ability of the refrigeration cycle equipment cannot be fully utilized. On the other hand, if such a margin is dispensed with, the circuit breaker may trip before the process of reducing the load is started, because of the detection error.

Patent reference 1 discloses use of a current transformer for detecting the effective value of the current flowing through a bridge circuit in a power converting apparatus (paragraph 0025).

### PATENT REFERENCES

Patent reference 1: Japanese Patent Publication 2018-7326 (paragraph 0025)

### SUMMARY

However, current transformers are associated with a problem that their detection accuracy is not sufficiently high, and the detection error is particularly large with regard to low frequency components.

An object of the present disclosure is to improve the detection accuracy of the input current to a power converting apparatus, and thereby to prevent the input current to the power converting apparatus from becoming excessive, and to enlarge the upper limit value of the input current up to which the supply of power to the load can be continued.

A power converting apparatus according to the present disclosure has:
a converter to convert AC power from an AC power supply into DC power and to output the DC power;
an inverter to convert the DC power outputted from said converter into AC power of a variable frequency and a variable voltage value and to supply the AC power to a load;
a shunt resistor to detect an output current of said converter; and
a control device to control said inverter based on the output current detected by said shunt resistor, wherein
said control device calculates an input current of said converter based on the output current detected by said shunt resistor, and, when the calculated input current becomes larger than a predetermined threshold value, changes a manner of operation of said inverter so as to reduce the input current of said converter.

According to the present disclosure, it is possible to detect the input current to the power converting apparatus with a high accuracy, and thereby to prevent the input current to the power converting apparatus from becoming excessive, and to enlarge the upper limit value of the input current up to which the power can be kept supplied to the load.

### BRIEF DESCRIPTION OF THE DRAWINGS

FIG. 1 is a diagram showing a power converting apparatus of a first embodiment.

FIG. 2 is a block diagram showing an example of a control device in FIG. 1.

FIG. 3 is a wiring diagram showing an example of a level shift circuit in FIG. 2.

FIGS. 4(a) and 4(b) are diagrams showing a relation between an input signal and an output signal of the level shift circuit in FIG. 3.

FIG. 5 is a diagram showing a path of a current flowing in a converter during a positive half cycle in a diode rectification mode.

FIG. 6 is a diagram showing a path of a current flowing in the converter during a negative half cycle in the diode rectification mode.

FIGS. 7(a) to 7(d) are diagrams showing an operation of the converter in the diode rectification mode.

FIG. 8 is a diagram showing a path of a current flowing in the converter during a positive half cycle in a synchronous rectification mode.

FIG. 9 is a diagram showing a path of a current flowing in the converter during a negative half cycle in the synchronous rectification mode.

FIGS. 10(a) to 10(f) are diagrams showing an operation of the converter in the synchronous rectification mode.

FIG. 11 is a diagram showing a path of a short-circuiting current flowing in the converter during a positive half cycle in a high power factor mode.

FIG. 12 is a diagram showing a path of a short-circuiting current flowing in the converter during a negative half cycle in the high power factor mode.

FIGS. 13(a) to 13(e) are diagrams showing an operation of the converter in the high power factor mode.

FIGS. 14(a) to 14(d) are diagrams showing a current detection operation by means of a shunt resistor in the high power factor mode.

FIG. 15 is a diagram showing a power converting apparatus of a second embodiment.

### DETAILED DESCRIPTION

### First Embodiment

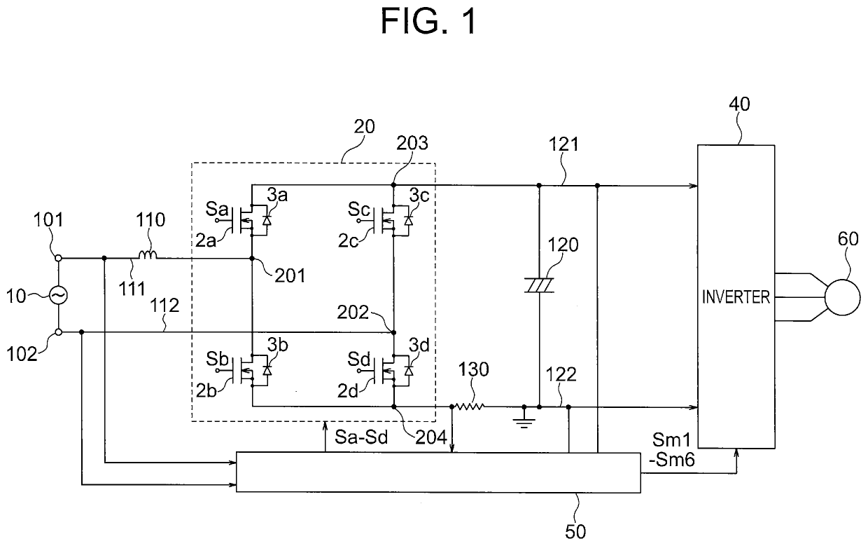

FIG. 1 shows a power converting apparatus 1 of a first embodiment, together with a motor which is a load of the power converting apparatus. In the following description, the motor is assumed to be a motor for a compressor in an air conditioner. However, the motor may be a motor used in refrigeration cycle equipment in a device other than an air conditioner, or may be a motor used in other equipment.

The illustrated power converting apparatus 1 has a converter 20, an inverter 40, a control device 50, a reactor 110, a smoothing capacitor 120, and a shunt resistor 130.

A first and a second AC-side terminals 201 and 202 of the converter 20 are connected via a first and a second AC wires 111 and 112 to an AC power supply 10. Specifically, the first AC-side terminal 201 is connected by the AC wire 111 to a first output terminal 101 of the AC power supply 10, and the second AC-side terminal 202 is connected by the AC wire 112 to a second output terminal 102 of the AC power supply 10.

The AC power supply 10 may be a commercial power supply, or a power supply formed of a private power generation system. When the AC power supply is a commercial power supply for household use, the AC power is supplied via a household outlet. A circuit breaker is provided in a wiring system connected to the outlet, and when the current supplied via the outlet to the power converting apparatus becomes excessive, the circuit breaker trips to interrupt the supply of the current.

The reactor 110 is provided at some part of the first AC wire 111.

The reactor 110 serves to boost the voltage and improve the power factor by storing the power supplied from the AC power supply 10 in the form of magnetic energy, and discharging the energy.

Single phase AC power is supplied from the AC power supply 10, and the converter 20 converts the AC power to DC power. A first DC-side terminal, i.e., a positive terminal 203, and a second DC-side terminal, i.e., a negative terminal 204 of the converter 20 are respectively connected to a first and a second DC bus lines 121 and 122, and the DC power generated by the converter 20 is supplied via the first and the second DC bus lines 121 and 122 to the inverter 40.

The smoothing capacitor 120 smooths an output voltage of the converter 20.

A positive electrode of the smoothing capacitor 120 is connected to the first DC bus line 121, and a negative electrode of the smoothing capacitor 120 is connected to the second DC bus line 122.

The inverter 40 converts the DC power outputted from the converter 20 into three-phase AC power of a variable frequency and a variable voltage value, and supplies the AC power to the motor 60, to cause the motor 60 to rotate.

The motor 60 is, for example, a motor for a compressor in an air conditioner.

The shunt resistor 130 is provided at some part of the second DC bus line 122, between the negative electrode of the smoothing capacitor 120 and the negative terminal 204 of the converter 20, and is used as a current detecting means for detecting an output current Is of the converter 20.

A voltage across both ends of the shunt resistor 130 is inputted to the control device 50.

The control device 50 detects the current flowing through the shunt resistor 130, i.e., the output current of the converter 20, based on the voltage across both ends of the shunt resistor 130, and controls the converter 20 and the inverter 40 based on the detected current value.

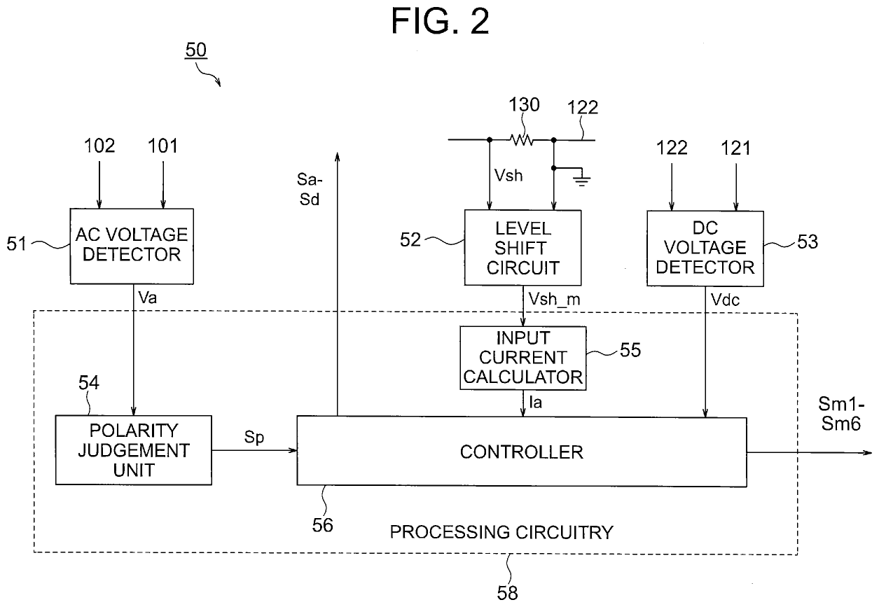

For example, the control device 50 has an AC voltage detector 51, a level shift circuit 52, a DC voltage detector 53, a polarity judgement unit 54, an input current calculator 55, and a controller 56, as shown in FIG. 2. The polarity judgement unit 54, the input current calculator 55, and the controller 56 are formed of processing circuitry 58. The processing circuitry 58 is formed, for example, of a microcomputer.

The AC voltage detector 51 is connected to the AC wire 111, at a point between the reactor 110 and the AC power supply, and to the AC wire 112, and detects the power supply voltage Va outputted from the first and the second output terminals 101 and 102 of the AC power supply 10, and supplies a signal indicating the value of the detected voltage to the control device 50.

In the following description, it is assumed that the instantaneous value of the power supply voltage Va represents the potential at the first output terminal 101 with reference to the potential at the second output terminal 102. The half cycle during which the potential of the first output terminal 101 with respect to the second output terminal 102 is positive is called a positive half cycle, and is denoted by a sign Hp. The half cycle during which the potential of the first output terminal 101 with respect to the second output terminal 102 is negative is called a negative half cycle, and is denoted by a sign Hn.

The polarity judgement unit 54 identifies the polarity of the voltage Va applied from the AC power supply 10, and supplies the controller 56 with a signal Sp indicating the polarity having been identified.

Outputted from the shunt resistor 130 is a signal indicating the voltage Vsh across both ends of the shunt resistor 130, the signal being denoted by the same sign, Vsh, as the voltage Vsh. The level shift circuit 52 in the control device 50 converts the level of the signal Vsh and outputs a signal Vsh_m obtained by the conversion. The signal Vsh and the signal Vsh_m both indicate the current flowing through the DC bus line 122.

Based on the signal Vsh_m, the input current calculator 55 calculates the value of the input current of the converter 20, as will be described later.

As the shunt resistor 130, a chip-type resistor is desirable. As the shunt resistor 130, it is desirable to use a resistor, such as a cement resistor or the like, which has a low temperature coefficient of resistance.

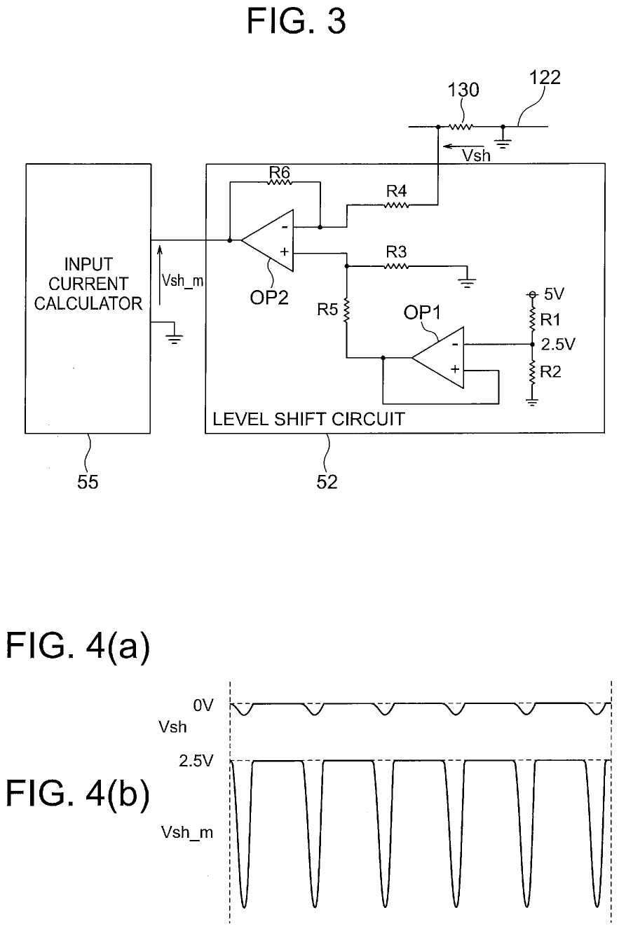

FIG. 3 shows an example of the level shift circuit 52. The illustrated level shift circuit 52 includes a voltage dividing circuit formed of resistors R1 and R2, a first operational amplifier OP1, and a second operational amplifier OP2. These operational amplifiers OP1 and OP2 operate under a single power supply of 5V.

The voltage dividing circuit divides the power supply voltage of 5V, to output a voltage of 2.5V. The voltage of 2.5V is inputted to an inverting input terminal of the first operational amplifier OP1. An output terminal of the first operational amplifier OP1 is coupled with a non-inverting input terminal of the first operation amplifier OP1. The first operational amplifier OP1 functions as a voltage follower, and the output of the first operational amplifier OP1 is kept at 2.5V.

The output of the first operational amplifier OP1 is inputted, via a resistor R5, to a non-inverting input terminal of the second operational amplifier OP2, as a bias voltage.

One end of the shunt resistor 130 (on the side of the negative electrode of the smoothing capacitor 120) is grounded, and when a current flows through the shunt resistor 130, the potential Vsh at the other end of the shunt resistor 130 becomes lower by the voltage drop across the shunt resistor. The above-mentioned potential Vsh at the other end is inputted, via a resistor R4 to an inverting input terminal of the second operational amplifier.

The output of the second operational amplifier OP2 is coupled, via a feedback resistor R6 to the inverting input terminal. An output voltage Vsh_m of the second operational amplifier OP2 varies around the bias voltage of 2.5V. The width of the variation is equal to a value obtained by multiplying the absolute value of the potential at the non-inverting input terminal by an amplification factor.

FIGS. 4(a) and 4(b) show an example of periodic variation in Vsh, and accompanying variation in Vsh_m.

As shown in FIG. 4(a), Vsh is referenced to 0, and varies in the negative direction, with increase in the instantaneous value of the current Is. When Vsh is 0, Vsh_m is kept at 2.5V. When Vsh varies in the negative direction, Vsh_m varies, from 2.5V, to a smaller value, i.e., toward zero. Compared with the variation in Vsh, the variation in Vsh_m has a larger width; that is the variation is amplified.

The signal Vsh_m outputted from the level shift circuit 52 is supplied, as a signal indicating the current Is, to the input current calculator 55.

Based on the signal Vsh_m supplied from the level shift circuit 52, the input current calculator 55 calculates the input current Ia of the converter 20. As the input current Ia, for example, an effective value is calculated. The calculated input current Ia is notified to the controller 56.

The DC voltage detector 53 detects a bus line voltage Vdc. The bus line voltage Vdc mentioned here is a DC voltage across the first DC bus line 121 and the second DC bus line 122, i.e., the DC voltage across the electrodes of the smoothing capacitor 120.

The value detected by the DC voltage detector 53 is used for control over the inverter 40.

The controller 56 controls the converter 20 based on the input current Ia. For the control over the converter 20, the controller 56 outputs signals Sa to Sd for controlling on-off of switching elements 2a to 2d of the converter 20, to be described later.

The controller 56 also controls the inverter 40, based on the input current Ia and the bus line voltage Vdc, as well as operation instructions from a remote controller, not shown, and the temperature of the space to be air-conditioned, detected by a temperature sensor, not shown. For the control over the inverter 40, the controller 56 outputs signals Sm1 to Sm6 for on-off control of switching elements in six arms, not shown, of the inverter 40.

The converter 20 is formed of a bridge-type rectifying circuit including a plurality of arms, specifically, four arms, each including a parallel connection of a diode and a switching element.

Input terminals, i.e., the AC-side terminals 201 and 202 of the converter 20 are connected to the AC wires 111 and 112, and output terminals, i.e., the positive and negative terminals 203 and 204 are respectively connected to the DC bus lines 121 and 122.

Specifically, a first switching element 2a is connected across the first AC-side terminal 201 and the positive terminal 203, a second switching element 2b is connected across the first AC-side terminal 201 and the negative terminal 204, a third switching element 2c is connected across the second AC-side terminal 202 and the positive terminal 203, and a fourth switching element 2d is connected across the second AC-side terminal 202 and the negative terminal 204.

Diodes 3a to 3d are respectively connected in parallel with the switching elements 2a to 2d, and each switching element and the diode connected in parallel therewith form an arm of the bridge circuit.

For example, each of the switching elements 2a to 2d is formed of a MOSFET (Metal-Oxide-Semiconductor Field-Effect Transistor).

When each of the switching elements 2a to 2d is formed of a MOSFET, their parasitic diodes are utilized as the diodes 3a to 3d.

The parasitic diode is formed of a pn junction between the source and the drain of each MOSFET, and the source side of the MOSFET (lower side in FIG. 1) functions as an anode, and the drain side (upper side in FIG. 1) functions as a cathode.

The drain of the MOSFET constituting the first switching element 2a and the drain of the MOSFET constituting the third switching element 2c are connected to the positive terminal 203, while the source of the MOSFET constituting the second switching element 2b and the source of the MOSFET constituting the fourth switching element 2d are connected to the negative terminal 204.

The converter 20 operates in a diode rectification mode, a synchronous rectification mode, or a high power factor mode. Generally, the mode is selected depending on the magnitude of the load.

When the load is relatively small, the diode rectification mode is selected.

The synchronous rectification mode is selected when the load is of an intermediate magnitude.

The high power factor mode is selected when the load is relatively large, e.g., near the rated value, or under an overload condition.

The operation of the converter in each mode will now be described.

In the diode rectification mode, the switching elements 2a to 2d are maintained in the off-state, and full-wave rectification is performed by having a current flow through the diodes 3a to 3d. The diode rectification mode is also called a passive mode.

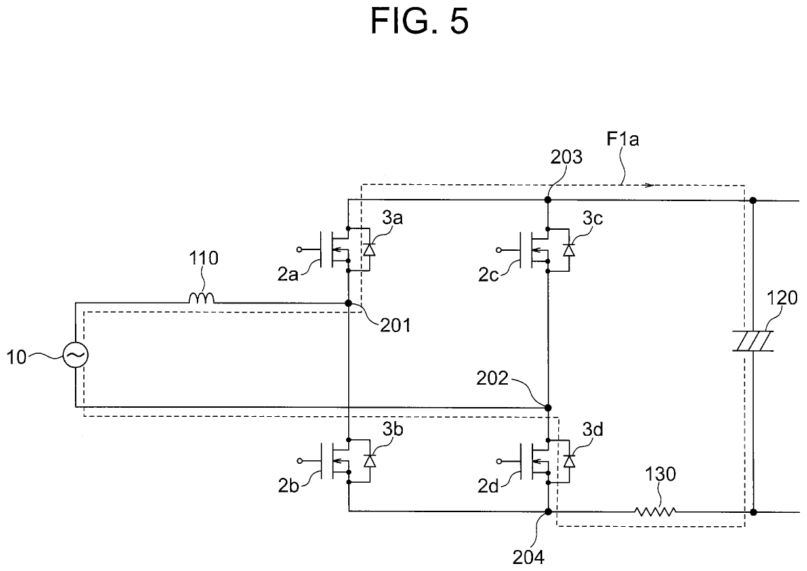

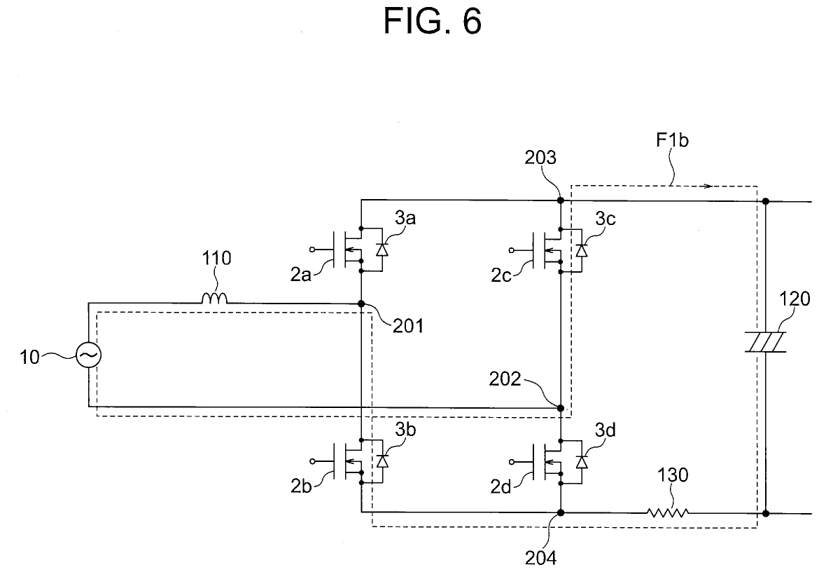

FIG. 5 and FIG. 6 show a path of the current Is flowing in the converter 20 in the diode rectification mode.

In a positive half cycle Hp, the current Is flows along a path indicated by an arrow-headed broken line Fla in FIG. 5, to charge the smoothing capacitor 120. In a negative half cycle Hn, the current Is flows along a path indicated by an arrow-headed broken line F1b in FIG. 6 to charge the smoothing capacitor 120.

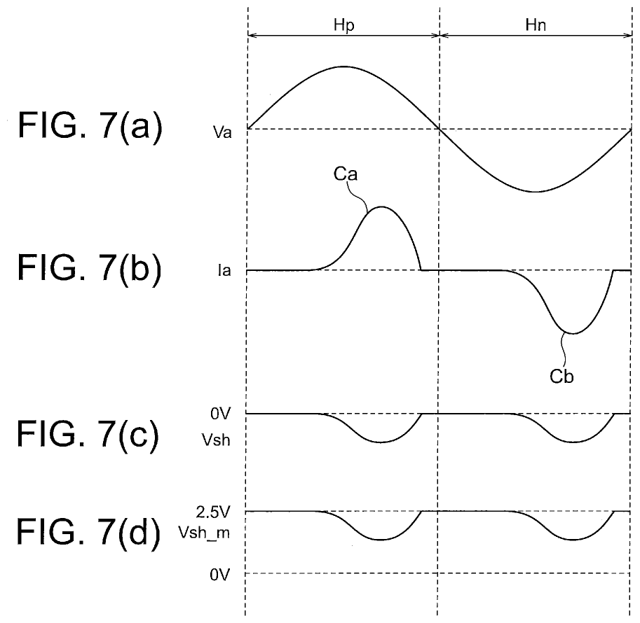

The current Is flowing through the shunt resistor 130 and the operation of the level shift circuit 52 when the converter 20 is operating in the diode rectification mode are explained with reference to FIGS. 7(a) to 7(d).

FIG. 7(a) show the power supply voltage Va.

FIG. 7(b) shows the input current Ia of the converter 20. Of the waveform in FIG. 7(b), the part indicated by a sign Ca is the current flowing along the path indicated by the broken line F1a, and the part indicated by a sign Cb is the current flowing along the path indicated by the broken line F1b.

FIG. 7(c) shows the voltage Vsh appearing across both ends of the shunt resistor 130.

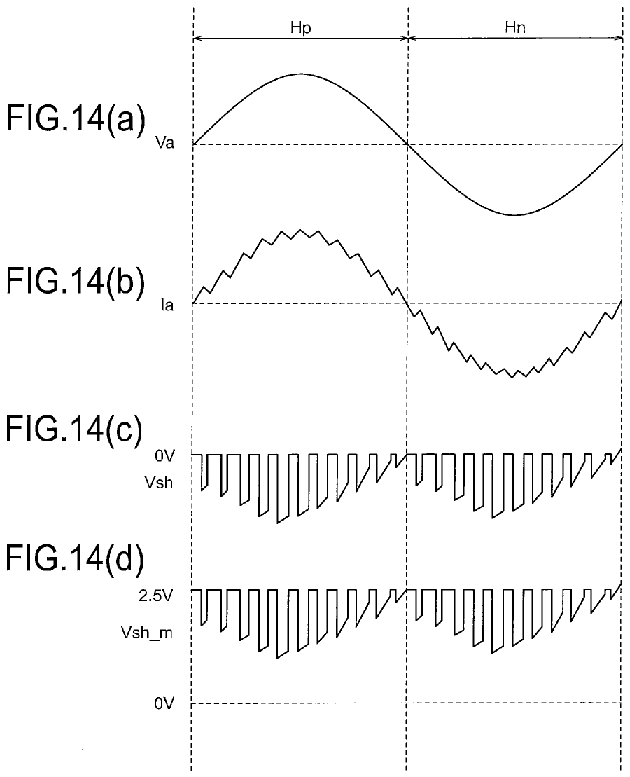

FIG. 7(d) shows the voltage signal Vsh_m obtained by level-shifting the voltage Vsh. In FIG. 7(d), the variation in the direction of the vertical axis is shown to be smaller compared with FIG. 4(b). This applies to FIG. 14(d) to be described later.

In the diode rectification mode, the switching loss at the switching elements 2a to 2d can be eliminated.

In the synchronous rectification mode, each of at least some of the switching elements 2a to 2d is made to be in the on-state in at least part of a period throughout which a current flows through the diode which is connected in parallel with the particular switching element, i.e., which is in the same arm as the particular switching element.

For example, each of the switching elements 2a and 2c in the arms connected to the positive terminal 203 is made to be in the on-state in at least part of a period throughout which a current flows through the diode connected in parallel with the particular switching element, and each of the switching elements 2b and 2d in the arms connected to the negative terminal 204 is maintained in the on-state during the half cycle including a period in which a current flows through the diode connected in parallel with the particular switching element, and is maintained in the off-state during the half cycle which includes no period in which a current flows through the diode connected in parallel with the particular switching element.

A period in which a current flows through each diode is a period in which a forward voltage is applied to the particular diode. The voltage applied to each diode is determined by the power supply voltage Va, the voltage across both electrodes of the smoothing capacitor 120, and the electromotive force or voltage drop of the reactor 110.

Whether a current is flowing through each diode is judged based on the polarity of the power supply voltage Va, and the instantaneous value of the output current Is.

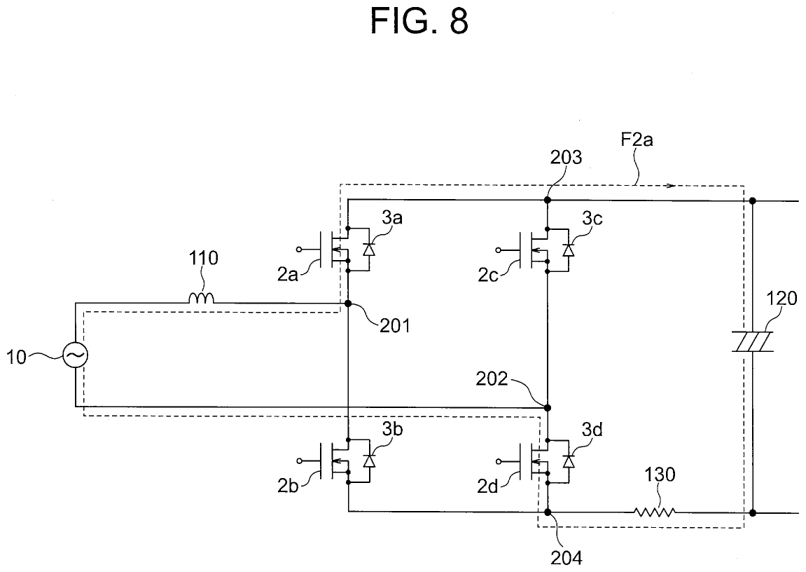

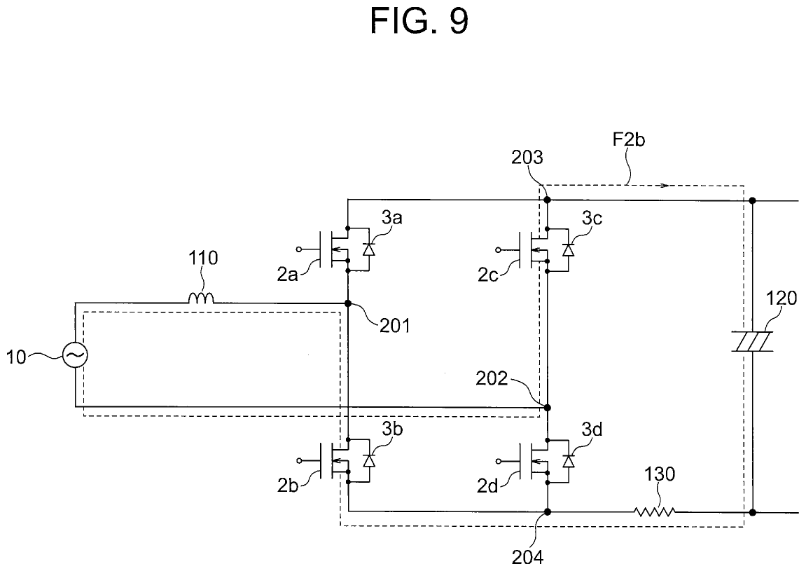

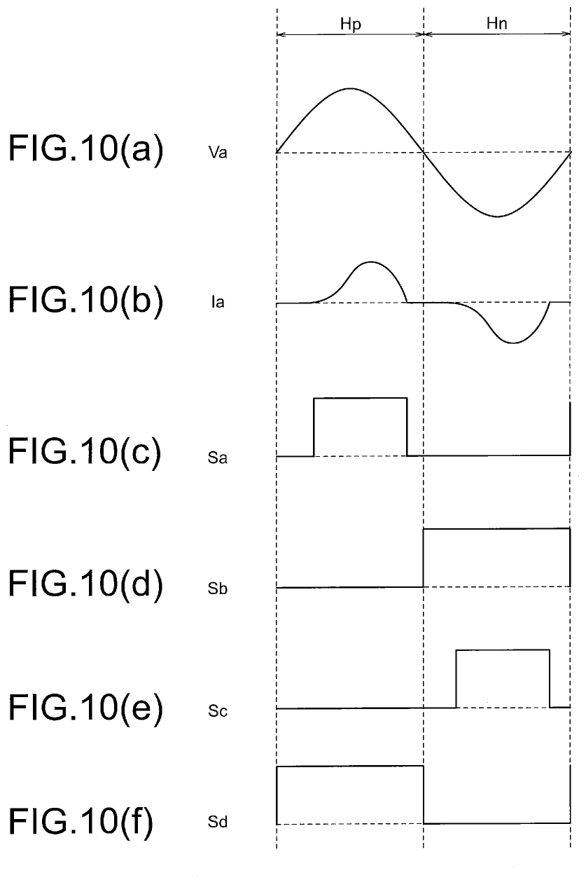

FIG. 8 and FIG. 9 show the flow of the current in the synchronous rectification mode, and FIGS. 10(a) to 10(f) show waveforms of the power supply voltage Va, the output current Is, and the signals Sa to Sd.

When each of the signals Sa to Sd in FIGS. 10(c) to 10(f) is High, the corresponding switching element is on, and when each of the signals Sa to Sd is Low, the corresponding switching element is off.

In a positive half cycle Hp, the switching elements 2b and 2c are maintained in the off-state (FIGS. 10(d) and 10(e)), the switching element 2d is maintained on (FIG. 10(f)) and the switching element 2a is made to be on in a period constituting at least part of the period throughout which a current flows through the parallel-connected diode 3a (FIG. 10(c)).

During the period when the switching elements 2a and 2d are on, the current Is flows mainly along a path indicated by an arrow-headed broken line F2a in FIG. 8, to charge the smoothing capacitor 120. During this period, a current also flows through the diode connected in parallel with the switching element in the on-state, but the amount of the current flowing through the diode is small compared with the amount of the current flowing through the switching element in the on-state.

In a negative half cycle Hn, the switching elements 2a and 2d are maintained in the off-state (FIGS. 10(c) and 10(f)), the switching element 2b is maintained on (FIG. 10(d)) and the switching element 2c is made to be on in a period constituting at least part of the period throughout which a current flows through the parallel-connected diode (FIG. 10(e)).

When the switching elements 2b and 2c are on, the current Is flows mainly along a path indicated by an arrow-headed broken line F2b in FIG. 9, to charge the smoothing capacitor 120. During this period, a current also flows through the diode connected in parallel with the switching element in the on-state, but the amount of the current flowing through the diode is small compared with the amount of the current flowing through the switching element in the on-state.

As described above, when the switching element is on, the current flowing through the parallel-connected diode is reduced. This is because the on-resistance of the switching element is smaller than the on-resistance of the diode. In particular, the resistance of the diode increases with increase in the current value, so that the proportion of the current flowing through the switching element becomes even greater.

By having most of the current flow through the switching element, the loss can be reduced and the power conversion efficiency can be heightened.

The current Is flowing through the shunt resistor 130 and the operation of the level shift circuit 52 when the converter 20 is operating in the synchronous rectification mode are similar to those explained with reference to FIGS. 7(a) to 7(d).

In the high power factor mode, control is so made that a short-circuiting current and a charging current flow alternately during each half cycle.

The short-circuiting current mentioned here is a current which flows, for example, along a path starting from the first output terminal 101 of the power supply 10, passing through the reactor 110, passing through two of the switching elements in the converter 20, and returning to the second output terminal 102. In this state, most of the output voltage of the power supply 10 is applied across the reactor 110.

The charging current mentioned here is a current which flows, for example, along a path starting from the first output terminal 101 of the power supply 10, passing through the reactor 110, passing through one of the switching elements of the converter 20, passing through the smoothing capacitor 120, passing through another of the switching elements of the converter 20, and returning to the second output terminal 102. By this charging current, the smoothing capacitor 120 is charged.

For causing the short-circuiting current and the charging current to flow alternately in each half cycle, the switching elements in the two arms connected to one of the AC-side terminals, among the plurality of arms, are controlled to be made on and off repeatedly and alternately, and, of the switching elements in the two arms connected to the other AC-side terminal, one is maintained in the on-state, and the other is maintained in the off-state.

For example, in either of a positive half cycle and a negative half cycle, the switching elements 2a and 2b in the arms connected to the first AC-side terminal 201 are controlled to be made on and off repeatedly and alternately. “To be made on and off alternately” means that when one is on the other is off.

In a positive half cycle, the switching element in the arm connected to the second AC-side terminal 202 and the positive terminal 203 is maintained in the off-state, and the switching element in the arm connected to the second AC-side terminal 202 and the negative terminal 204 is maintained in the on-state.

In a negative half cycle, the switching element in the arm connected to the second AC-side terminal 202 and the positive terminal 203 is maintained in the on-state, and the switching element in the arm connected to the second AC-side terminal 202 and the negative terminal 204 is maintained in the off-state.

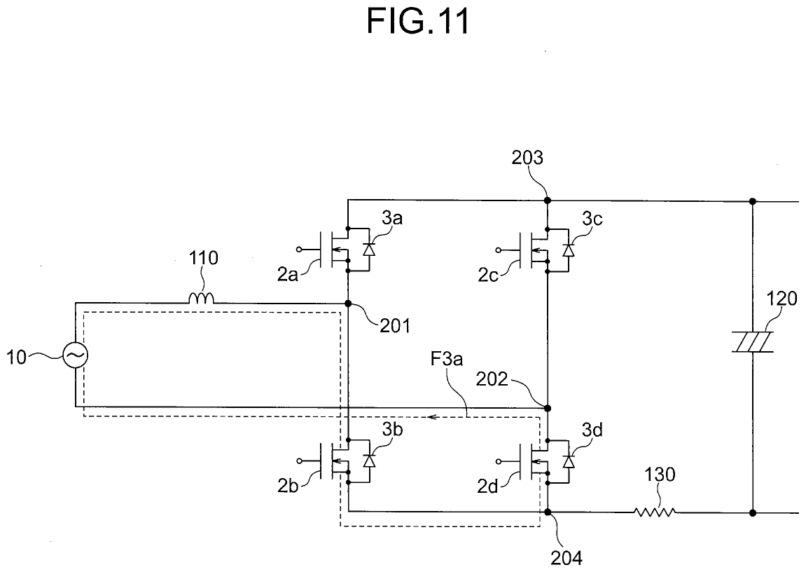

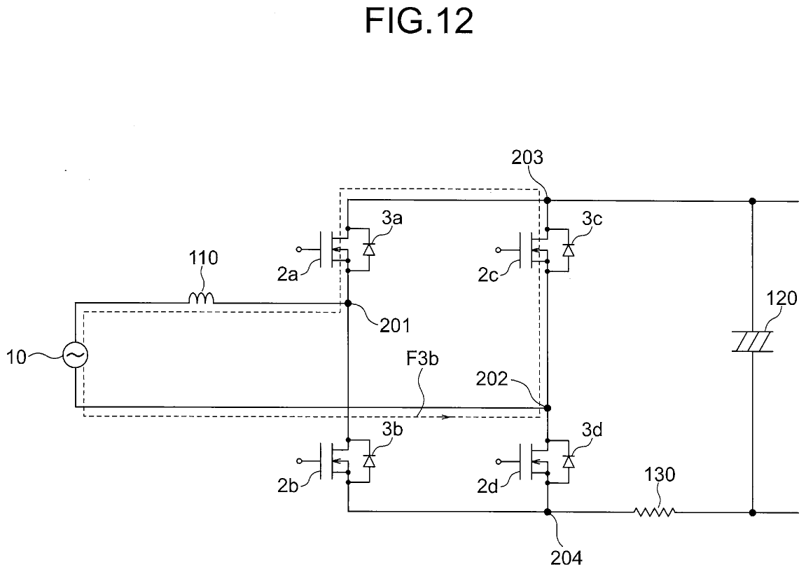

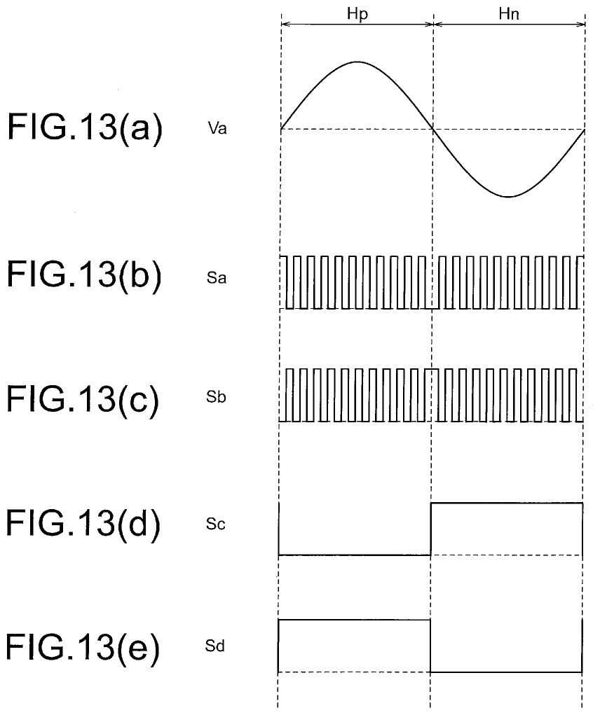

More detailed description will now be made with reference to FIG. 11, FIG. 12, and FIGS. 13(a) to 13(e), as well as FIG. 8 and FIG. 9 on a specific example.

In a positive half cycle Hp, the switching element 2d is maintained in the on-state (FIG. 13(e)), the switching element 2c is maintained in the off-state (FIG. 13(d)), and the switching element 2aand the switching element 2b are made to be on alternately (FIGS. 13(b) and 13(c)).

During the period when the switching element 2b is on, and hence the period when the switching element 2b and the switching element 2d are both on, a short-circuiting current flows along a path indicated by an arrow-headed broken line F3a in FIG. 11. This current increases with the lapse of time. By the increase in the current, magnetic energy is stored in the reactor 110.

Also, because of this current, distortion in the current waveform is reduced, and the current waveform becomes closer to a sinusoidal wave. Accordingly, the power factor of the power converting apparatus is improved, and high-frequency components contained in the current can be reduced.

During the period when the switching element 2a is on, and hence the period when the switching element 2a and the switching element 2d are both on, a charging current flows as indicated by the arrow-headed broken line F2a in FIG. 8. As this current flows, the voltage across the smoothing capacitor 120 gradually increases. During this period, the magnetic energy stored in the reactor 110 is also used for the charging of the smoothing capacitor 120. Accordingly, the smoothing capacitor 120 can be charged to a higher voltage. That is, a boosting effect is obtained.

In a negative half cycle Hn, the switching element 2c is maintained in the on-state (FIG. 13(d)), the switching element 2d is maintained in the off-state (FIG. 13(e)), and the switching element 2a and the switching element 2b are made to be on alternately (FIGS. 13(b) and 13(c)).

During the period when the switching element 2a is on, and hence the period when the switching element 2a and the switching element 2c are both on, a short-circuiting current flows as indicated by an arrow-headed broken line F3b in FIG. 12. This current increases with the lapse of time, and, accordingly, magnetic energy is stored in the reactor 110.

Also, because of this current, distortion in the current waveform is reduced, and the current waveform becomes closer to a sinusoidal wave. Accordingly, the power factor of the power converting apparatus is improved, and high frequency components included in the current can be reduced.

During the period when the switching element 2b is on, and hence the period when the switching element 2b and the switching element 2c are both on, a charging current flows as indicated by the arrow-headed broken line F2b in FIG. 9. As this current flows, the voltage across the smoothing capacitor 120 gradually increases. During this period, the magnetic energy stored in the reactor 110 is also used for the charging of the smoothing capacitor 120. Accordingly, the smoothing capacitor 120 can be charged to a higher voltage. That is, a boosting effect is obtained.

The on-off cycle period of the switching elements 2a and 2b is short as illustrated in FIGS. 13(b) and 13(c). The on-off cycle period may be constant throughout each half cycle, or may be varied during each half cycle.

Also, the proportion (on-duty) with which the time for which each of the switching elements 2a and 2b is on, i.e., the time for which the signal Sa or Sb is High occupies in each cycle period may vary during each half cycle period.

For example, in a positive half cycle Hp, the on-duty of the signal Sb may be made larger when the instantaneous value of the power supply voltage Va shown in FIG. 13(a) is larger, i.e., toward the middle time point in each half cycle period. In a negative half cycle Hn, the on-duty of the signal Sa may be made larger when the instantaneous value of the power supply voltage Va shown in FIG. 13(a) is larger, i.e., toward the middle time point in each half cycle period.

It is desirable that the on-duty of each of the signals Sa and Sb at each time point in each half cycle be so determined that the input current Ia comes to have a waveform closer to a sinusoidal waveform.

Incidentally, near the starting point and the end point of each half cycle, the absolute value of the power supply voltage Va becomes small, and the voltage across the AC-side terminals 201 and 202 of the converter 20 becomes smaller than the bus line voltage Vdc. During such periods, the switching elements 2a to 2d need to be so controlled as to prevent the current from flowing backward from the smoothing capacitor 120 through the converter 20 to the AC power supply 10. Illustration on this point is omitted.

Description on the current Is flowing through the shunt resistor 130 and the operation of the level shift circuit 52 when the converter 20 is operating in the high power factor mode is made with reference to FIGS. 14(a) to 14(d).

FIG. 14(a) shows the power supply voltage Va.

FIG. 14(b) shows the input current Ia of the converter 20.

FIG. 14(c) shows the voltage Vsh appearing across both ends of the shunt resistor 130.

FIG. 14(d) shows the voltage signal Vsh_m obtained by level-shifting Vsh.

As mentioned above, when the short-circuiting current is flowing, the current Is is zero, so that the voltage Vsh is 0V (FIG. 14(c)), and the voltage signal Vsh_m is maintained at 2.5V (FIG. 14(d)). When the current Is is flowing, the voltage Vsh is of a value lower than 0V, and the voltage signal Vsh_m is of a value lower than 2.5V. The difference between Vsh_m and 2.5V at each time point is proportional to the absolute value of Vsh.

Because of the short-circuiting current, the power factor is improved, and the overall waveform of the input current Ia (FIG. 14(b)) of the converter 20 becomes closer to a sinusoidal wave.

As was mentioned above, the control device 50 controls the converter 20 and the inverter 40.

In the control over the converter 20, the control device 50 selects the operation mode depending on the input current Ia, and controls the on-off of the switching elements 2a to 2d when the selected operation mode is the synchronous rectification mode or the high power factor mode.

For example, the control over the converter 20 is made in the following manner.

When the input current Ia is not larger than a first threshold value, the converter 20 is made to operate in the diode rectification mode.

When the input current Ia is larger than the first threshold value and is not larger than a second threshold value, the converter 20 is made to operate in the synchronous rectification mode.

When the input current Ia is larger than the second threshold value, the converter 20 is made to operate in the high power factor mode.

As was mentioned above, the input current Ia is calculated from the value of the output current Is detected by the shunt resistor 130.

For controlling the switching elements 2a to 2d based on the polarity, the output of the polarity judgement unit 54 is used.

Whether a current is flowing through each diode is judged based on the polarity of the power supply voltage Va and the current flowing through the shunt resistor 130. That is, for each arm connected to the positive terminal 203, if a current is flowing through the shunt resistor 130 in a half cycle in which the potential at the output terminal (101 or 102) of the AC power supply 10 connected to the AC-side end of the particular arm is higher than the potential at the other output terminal (102 or 101) of the AC power supply 10, then it is judged that a current is flowing through the diode in the particular arm.

Similarly, for each arm connected to the negative terminal 204, if a current is flowing through the shunt resistor 130 in a half cycle in which the potential at the output terminal (102 or 101) of the AC power supply 10 connected to the AC-side end of the particular arm is lower than the potential at the other output terminal (101 or 102) of the AC power supply 10, then it is judged that a current is flowing through the diode in the particular arm.

As was mentioned above, the control device 50 also controls the inverter 40.

Normally, the inverter 40 is controlled depending on the state of the load.

The motor 60 which is a load of the inverter 40 is a motor for a compressor in an air conditioner, as mentioned above.

In such a case, decision on the rotational speed of the motor is made based on the difference between the detected temperature of the air-conditioned space and the set temperature, the operation mode selected by the user, and the like.

In the present embodiment, in addition to the above-mentioned operation generally practiced, the inverter is controlled depending on the input current Ia. This is to prevent interruption of the current by the circuit breaker due to the input current Ia becoming excessive. The input current Ia is judged to be excessive when it exceeds a fourth threshold value larger than the above-mentioned third threshold value.

The input current may become excessive when the load of the inverter 40 becomes too large. The input current may also become excessive upon failure of the switching elements during the high power factor operation of the converter 20.

For example, when the input current Ia becomes excessive, the control device 50 lowers the output frequency and the output voltage of the inverter 40. By doing so, the input current of the inverter 40 can be reduced, and accordingly the input current of the converter 20 can also be reduced.

Alternatively, when the input current Ia becomes excessive, the control device 50 may perform control for reducing the torque command thereby to reduce the output torque of the motor 60. This also makes it possible to reduce the input current of the inverter 40, thereby reducing the input current of the converter 20.

However, it takes a longer time for the input current to be reduced after conducting the control to reduce the torque command.

Therefore, in general, it is preferable to select the method in which the output frequency and the output voltage of the inverter 40 are lowered.

Also, the control may be so made that the output frequency of the inverter 40 is lowered, and, if the input current continues to be excessive, the torque command is reduced.

As has been described, according to the present embodiment, the output current Is is detected using the shunt resistor 130, and the input current Ia is calculated based on the result of the detection. Therefore, the input current Ia can be determined accurately. Therefore, the margin taking account of the detection accuracy can be made small.

If the detection accuracy is low, the margin has to be made large. As a result, a protective action for reducing the input current may be taken when actually there is still room. With such a configuration, the ability of the power converting apparatus cannot be fully utilized. According to the present embodiment, because the input current can be calculated with a high accuracy, the margin can be made small, and the protective action is started only when the input current Ia becomes larger, and of a value closer to the upper limit value (current capacity). Therefore, the ability of the power converting apparatus can be fully exhibited. For example, if the power converting apparatus is for driving a motor for the compressor in an air conditioner, the effect on the operation of the air conditioner can be reduced.

Also, since the shunt resistor 130 is cheap, the cost for the current detection can be lowered.

The embodiment described above can be modified in various ways.

For instance, in the above example, the control in the synchronous rectification mode is so made that each of the switching elements 2a and 2c in the arms connected to the positive terminal 203 is made to be in the on-state in at least part of the period throughout which a current flows through the parallel-connected diode, and each of the switching elements 2b and 2d in the arms connected to the negative terminal 204 is maintained in the on-state during the half cycle including a period in which a current flows through the parallel connected diode, and is maintained in the off-state during the half cycle which includes no period in which a current flows through the parallel connected diode.

Alternatively, the control may be so made that each of the switching elements 2b and 2d in the arms connected to the negative terminal 204 is made to be in the on-state in at least part of a period throughout which a current flows through the parallel-connected diode, and each of the switching elements 2a and 2c in the arms connected to the positive terminal 203 is maintained in the on-state during the half cycle including a period in which a current flows through the parallel connected diode, and is maintained in the off-state during the half cycle which includes no period in which a current flows through the parallel connected diode.

Also, in FIG. 1, the signals Sa to Sd applied to the gates of the MOSFETs constituting the switching elements 2a to 2d are shown to be outputted from the control device 50.

Alternatively, the configuration may be such that the converter 20 is provided with a drive signal generating circuit which converts signals outputted from the control device 50 and applies the converted signals to the gates of the MOSFETs.

For instance, the signal applied to the gate of each of the MOSFETs constituting the switching elements 2a and 2c need to be one referenced to the source of the particular MOSFET. On the other hand, it is easier for the control device 50 to be so configured as to output signals referenced to the ground potential. Moreover, the signals applied to the gates of the MOSFETs may have to be of a larger magnitude than the signals generally generated in the control device 50. Therefore, the above-mentioned drive signal generating circuit may be provided to convert the signals outputted from the control device 50 into signals applied to the gates of the MOSFETs.

Furthermore, in the above-described example, MOSFETs are used as the switching elements. However, switching elements other than MOSFETs may be used.

In the above-described example, the shunt resistor 130 is inserted in the second bus line 122 between the negative electrode of the smoothing capacitor 120 and the negative terminal of the converter 20. The location at which the shunt resistor 130 is inserted is not limited to the above example. It is sufficient if it is inserted in a path through which the output current of the converter 20 flows.

### Second Embodiment

In the first embodiment described above, the inverter 40 drives the motor 60 for a compressor in an air conditioner. The power converting apparatus of a second embodiment has an additional function of driving a fan in the air conditioner.

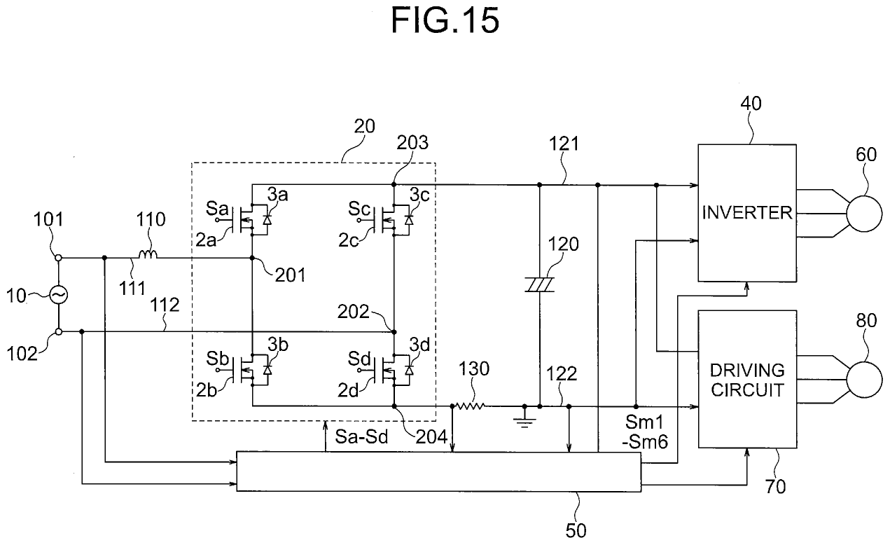

FIG. 15 shows the power converting apparatus of the second embodiment.

The power converting apparatus shown in FIG. 15 is generally identical to the power converting apparatus shown in FIG. 1, but a driving circuit 70 is added. The driving circuit 70 receives the DC power outputted from the converter 20 and drives a motor 80 for the fan. The driving circuit 70 may be one provided with an inverter similar to the inverter 40.

When the input current Ia becomes excessive, the control device 50 lowers the output frequency and the output voltage of the inverter 40, and also causes the driving circuit 70 to raise the rotational speed of the motor 80.

The driving circuit 70 is for driving the motor 80 for the fan, so that its power consumption is small compared with the inverter for driving the motor 60 for the compressor. That is, raising the rotational speed of the motor 80 for the fan does not cause substantial increase in the power.

That is, by lowering the output frequency and the output voltage of the inverter 40 to lower the rotational speed of the compressor, and, at the same time, increasing the rotational speed of the fan, the total power consumption is reduced.

By adopting such a scheme, the minimum air conditioning operation is maintained, while at the same time the power consumption is reduced, and the input current Ia of the converter 20 is reduced, making it possible to prevent the allowable input value from being exceeded.

So far, the power converting apparatus according to the embodiments of the present disclosure have been described. Various modifications can be applied to the power converting apparatus according to the present disclosure.

For example, modifications similar to the modifications which were described in connection with the first embodiment can be applied to the second embodiment.

Also, in the first and second embodiments, the level shift circuit 52 is used for converting the voltage signal obtained from the shunt resistor 130, and inputting the converted signal into the controller 56, but a circuit other than the illustrated level shift circuit may be used for the conversion of the voltage signal obtained from the shunt resistor 130.

Also, in the first and second embodiments described above, the load of the power converting apparatus includes the motor for the compressor in an air conditioner. The power converting apparatus according to the present disclosure can be applied to cases where the load is other than a motor for a compressor in an air conditioner.

1. A power converting apparatus having:
a converter to convert AC power from an AC power supply into DC power and to output the DC power;
an inverter to convert the DC power outputted from said converter into AC power of a variable frequency and a variable voltage value and to supply the AC power to a load;
a shunt resistor to detect an output current of said converter; and
a control device to control said inverter based on the output current detected by said shunt resistor, wherein
said control device calculates an input current of said converter based on the output current detected by said shunt resistor, and, when the calculated input current becomes larger than a predetermined threshold value, changes a manner of operation of said inverter so as to reduce the input current of said converter,
wherein
said converter is formed of a bridge-type rectifying circuit having a plurality of arms each including a parallel connection of a diode and a switching element,
said control device selects one of:
a diode rectification mode in which the switching elements in said plurality of arms are all maintained in an off-state, and rectification is performed only by the diodes;
a synchronous rectification mode in which the switching element in each of at least some of the arms among said plurality of arms is made to be on in at least part of a period throughout which a current flows through the diode in the particular arm; and
a high power factor mode in which a short-circuiting current and a charging current are made to flow alternately by causing the switching elements in two arms connected to one of AC-side terminals, among said plurality of arms, to be made on and off repeatedly and alternately, and
causes said converter to operate in the selected mode,
wherein, when said control device detects that said input current is larger than said threshold value, while said converter is operating in said high power factor mode, said control device causes said converter to transit to said synchronous rectification mode or said diode rectification mode.

2. The power converting apparatus as set forth in claim 1, wherein said threshold value is determined based on a current capacity of said AC power supply.

3. The power converting apparatus as set forth in claim 1, wherein
said AC power supply is a single phase AC power supply, and
said power converting apparatus further has a reactor inserted between one of AC-side terminals of said converter and an output terminal of said AC power supply.

4. The power converting apparatus as set forth in claim 1, further having a smoothing capacitor connected on an output side of said converter to smooth an output voltage of said converter, wherein
said shunt resistor is connected between a negative electrode of said smoothing capacitor and a negative terminal of said converter.

5. The power converting apparatus as set forth in claim 1, wherein said control device lowers an output frequency of said inverter, as a form of changing of the manner of operation.

6. The power converting apparatus as set forth in claim 5, wherein
said inverter is used for driving a motor, and
by lowering the output frequency of said inverter, a rotational speed of said motor is lowered.

7. The power converting apparatus as set forth in claim 6, wherein,
if said input current continues to be larger than said threshold value even after lowering the output frequency of said inverter, said control device reduces a torque command in the control of said motor, as a form of changing the manner of operation.

8. The power converting apparatus as set forth in claim 1, wherein
said inverter is used for driving a motor,
said control device reduces a torque command in the control of said motor, as a form of changing the manner of operation.

9. (canceled)

10. The power converting apparatus as set forth in claim 1, wherein
said control device
detects a polarity of an output voltage of said AC power supply, and
controls on-off of said switching elements in said synchronous rectification mode and said high power factor mode based on a result of the detection of the polarity.

11. (canceled)

12. The power converting apparatus as set forth in claim 1, wherein
said AC power supply is a power supply supplied via a household outlet, and
said threshold value is a current capacity value of the outlet or a circuit breaker provided in a wiring system connected to the outlet.

13. The power converting apparatus as set forth in claim 1, wherein said shunt resistor is a chip-type shunt resistor.

14. The power converting apparatus as set forth in claim 1, wherein said shunt resistor is a cement resistor.

15. An air conditioner having the power converting apparatus as set forth in claim 5, a compressor, and a fan, wherein
said inverter is for driving a motor for said compressor,
said power converting apparatus is also provided with a driving circuit to receive the DC power outputted from said converter and to drive a motor for said fan, and
when said control device lowers the output frequency of said inverter, upon said input current becoming larger than said threshold value, together with such control, said driving circuit raises a rotational speed of the motor for said fan.

16. Refrigeration cycle equipment having the power converting apparatus as set forth in claim 1.

17. An air conditioner having a power converting apparatus, a compressor, and a fan, wherein
said power converting apparatus has:
a converter to convert AC power from an AC power supply into DC power and to output the DC power;
an inverter to convert the DC power outputted from said converter into AC power of a variable frequency and a variable voltage value and to supply the AC power to a load;
a shunt resistor to detect an output current of said converter; and
a control device to control said inverter based on the output current detected by said shunt resistor, wherein
said control device calculates an input current of said converter based on the output current detected by said shunt resistor, and, when the calculated input current becomes larger than a predetermined threshold value lowers an output frequency of said inverter,
said inverter is for driving a motor for said compressor,
said power converting apparatus is also provided with a driving circuit to receive the DC power outputted from said converter and to drive a motor for said fan, and
when said control device lowers the output frequency of said inverter, upon said input current becoming larger than said threshold value, together with such control, said driving circuit raises a rotational speed of the motor for said fan.

18. The air conditioner as set forth in claim 17, wherein said threshold value is determined based on a current capacity of said AC power supply.

19. The air conditioner as set forth in claim 17 wherein
said AC power supply is a single phase AC power supply, and
said power converting apparatus further has a reactor inserted between one of AC-side terminals of said converter and an output terminal of said AC power supply.

20. The air conditioner as set forth in claim 17, further having a smoothing capacitor connected on an output side of said converter to smooth an output voltage of said converter, wherein
said shunt resistor is connected between a negative electrode of said smoothing capacitor and a negative terminal of said converter.

21. The air conditioner as set forth in claim 17, wherein
said inverter is used for driving a motor, and
by lowering the output frequency of said inverter, a rotational speed of said motor is lowered.
